(19) United States
(12) Patent Application Publication
(10) Pub. No.: US 2020/0215817 A1
(43) Pub. Date: Jul. 9, 2020

(54) Pressure adjusting device of inkjet printer and adjusting method thereof

(71) Applicant: Gosantech Co., Ltd., Cheonan-si (KR)

(72) Inventors: Sung-hee Lee, Cheonan-si (KR); Kwang-su Kim, Cheonan-si (KR)

(21) Appl. No.: 16/361,544

(22) Filed: Mar. 22, 2019

(30) Foreign Application Priority Data
Jan. 8, 2019 (KR) 10-2019-0002090

(51) Int. Cl. B41J 2/045

(52) U.S. Cl. CPC B41J 2/04563; B41J 2/04586

(57) ABSTRACT

The present invention relates to a pressure adjusting device which maintains the precision of pressure control even during use of the inkjet printer and the pressure adjusting device includes an output tube which is connected to an ink reservoir; at least one pressure generator which is capable of changing the pressure in the ink reservoir; an adjusting valve which is positioned between the pressure generator and the output tube; a control unit which controls the adjusting valve to control an output pressure; a pressure sensor which measures pressure information which is output to the output tube so that the control unit is capable of adjusting the adjusting valve; and a temperature sensor which measures temperature information so that the control unit is capable of performing a temperature correction with respect to the pressure information measured at the pressure sensor.

### BACKGROUND

The present invention relates to a pressure adjusting device connected to an ink reservoir of an inkjet printer, and more particularly to a pressure adjusting device applied to an inkjet printer used in an industrial field.

In general, an inkjet method for jetting liquid ink on a surface of a medium in a droplet form according to a shape signal is used not only for printing which writes a document or a bill but also for a solution process in a semiconductor or a display field.

The application range of inkjet printing which can form a complicated pattern on a substrate or accurately discharge ink only at a specific position is widening. A small inkjet printer for document writing has a form in which ink is stored in an inkjet head which discharges ink droplets, but since a large-sized printer for document writing or an inkjet printer manufactured for industrial use utilizes a large amount of ink, the ink reservoir which stores ink and the inkjet head have structures which are separated from each other.

Meanwhile, so as to discharge an accurate amount of ink during the inkjet printing process, it is necessary to maintain a meniscus state where the ink, which is in a state of being prepared for discharge from the inkjet head, is in a curved state of being recessed inward by capillary phenomenon with reference to the nozzle inlet. So as to achieve this, generally, the position of the ink reservoir is positioned higher than the inkjet head, and instead, the negative pressure is generated in the ink reservoir by a pressure adjusting device connected to the ink reservoir, thereby preventing the ink from flowing down from the inkjet head and thus maintaining the meniscus state. At this time, when the inkjet printer is operated since the ink is continuously circulated while the ink is discharged through the inkjet head, the pressure adjusting device continues to operate so as to constantly control the internal pressure of the ink reservoir.

However, during the operation process of the inkjet printer, a phenomenon that the pressure control by the pressure adjusting device is slightly shifted is generated, and although the error in the pressure control process is not a big problem in the general case, the error in the pressure control process is gradually becoming a problem in the process of producing the latest ultra-precision products.

### PRIOR ART DOCUMENT

### Patent Literature

(Patent Document 1) Korean Patent No. 10-1694278

### SUMMARY

The present invention has been made to solve the problems of the prior art described above, and an objective of the present invention is to provide a pressure adjusting device which maintains the precision of pressure control even during use of an inkjet printer.

To achieve the objective described above, according to the present invention, there is provided a pressure adjusting device of an inkjet printer including: an output tube which is connected to an ink reservoir; at least one pressure generator which is capable of changing a pressure in the ink reservoir; an adjusting valve which is positioned between the pressure generator and the output tube; a control unit which controls the adjusting valve to control an output pressure; a pressure sensor which measures pressure information output to the output tube so that the control unit can adjust the adjusting valve; and a temperature sensor which measures temperature information so that the control unit can perform temperature correction on the pressure information measured by the pressure sensor.

Since the pressure adjusting device of the present invention can control the output based on a value measured by a sensor installed in the device, there is an advantage that the output adjusting can be easily performed even if the pressure adjusting device is modularized. At this time, the precision of the pressure sensor installed in the device may be a problem, but the precision problem of the sensor installed in the device can be solved through the correction by the temperature sensor.

The temperature sensor preferably measures the temperature around the pressure sensor.

The pressure generator may include a negative pressure generator for generating a negative pressure and a positive pressure generator for generating a positive pressure, the adjusting valve may include a first adjusting valve which is connected to a side of the negative pressure generator and a second adjusting valve which is connected to a side of the positive pressure generator, and may have a configuration in which the output tube is branched to be connected to the first adjusting valve and the second adjusting valve, respectively. At this time, it is preferable that the pressure sensor measures the pressure at the point where the output tube is not branched.

According to another aspect of the present invention, there is provided a pressure adjusting device of an inkjet printer which is connected to an ink reservoir through a tube to adjust an internal pressure of the ink reservoir, the pressure adjusting device including: a control unit which controls a pressure output from the pressure adjusting device; a pressure sensor which measures a pressure in the pressure adjusting device to provide pressure information to the control unit; and a temperature sensor which measures temperature information in the pressure adjusting device so that the control unit is capable of performing temperature correction on the pressure information measured by the pressure sensor.

At this time, other configurations other than those included in the pressure adjusting device can be applied in a scope which does not impair the features of the present invention without limitation, and therefore, detailed description thereof will be omitted.

It is preferable that two or more pressure sensors are installed and a temperature sensor is provided for each of the plurality of pressure sensors.

According to another aspect of the present invention, there is provided a control method of a pressure adjusting device which is connected to an ink reservoir through a tube to adjust an internal pressure of the ink reservoir, the method including: controlling the output pressure of the pressure adjusting device based on the pressure in the pressure adjusting device and performing correction according to the temperature in the pressure adjusting device with respect to the pressure in the pressure adjusting device to control the output pressure.

The present invention configured as described above performs the control based on the pressure sensor installed therein, and further includes a temperature sensor which measures the temperature around the pressure sensor and performs correction according to the temperature, and thus there is an effect that the actual output pressure can be controlled more accurately.

In addition, by accurately controlling the output pressure of the pressure adjusting device, the effects that the internal pressure of the ink reservoir can be more accurately controlled, and finally, the precision of the inkjet printer can be further improved can be obtained.

### BRIEF DESCRIPTION OF THE DRAWINGS

FIG. 1 is a schematic diagram illustrating a portion of the configuration of a pressure adjusting device according to an embodiment of the present invention.

FIG. 2 is a graph illustrating a comparison between a pressure measured by a pressure sensor of a pressure adjusting device according to an embodiment of the present invention and an actual pressure measured externally.

FIG. 3 is a graph in which the temperature change with time is added to the graph of FIG. 2.

FIG. 4 is a temperature compensation table written for correction with respect to a pressure sensor in a pressure adjusting device according to an embodiment of the present invention.

FIG. 5 is a graph comparing an output pressure of a sensor corrected by reflecting the temperature compensation of a pressure adjusting device according to an embodiment of the present invention, and an actual pressure measured externally.

### DETAILED DESCRIPTION OF THE EMBODIMENTS

Referring to the accompanying drawings, an embodiment according to the present invention will be described in detail.

However, the embodiment of the present invention can be modified into various other forms, and the scope of the present invention is not limited to the embodiment described below. The shape, the size, or the like of the elements in the drawings may be exaggerated for clearer explanation and the same elements are denoted by the same reference numerals in the drawings.

In addition, throughout the specification, when a part is referred to as being “connected” to another part, it includes not only in a case of being “directly connected” but also in a case of being “electrically connected” with another part therebetween. In addition, when a part is referred to as being “including” or “having” a component, it is to be understood that this does not exclude other components unless specifically stated otherwise, but may further include or has other components.

Also, the terms “first”, “second”, and the like are used to distinguish one component from another component and the scope of the right should not be limited by these terms. For example, the first component may be referred to as a second component, and similarly, the second component may also be referred to as a first component.

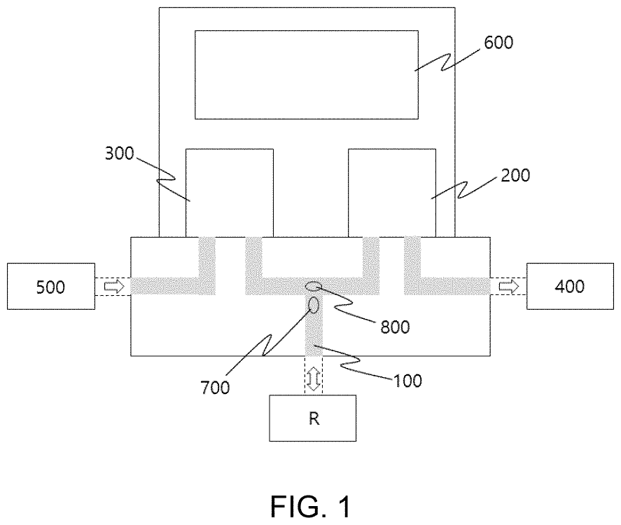

FIG. 1 is a schematic diagram illustrating a portion of the configuration of a pressure adjusting device according to an embodiment of the present invention.

The pressure adjusting device according to the present embodiment includes an output tube 100, a first adjusting valve 200, a second adjusting valve 300, a negative pressure generator 400, a positive pressure generator 500, a control unit 600, a pressure sensor 700, and a temperature sensor 800.

The output tube 100 is a portion which is connected to the ink reservoir R through a tube and adjusts the pressure of the ink reservoir by a method of sucking air from the ink reservoir through the output tube 100 or injecting air into the ink reservoir.

In the present embodiment, the output tube 100 is branched into two tubes, and the branched tubes are connected to the first adjusting valve 200 and the second adjusting valve 300, respectively.

The first adjusting valve 200 is installed in the middle at which one side tube branched from the output tube 100 is connected to the negative pressure generator 400 and thus the device controls the operation of the first adjusting valve so that the amount of air to be sucked from the ink reservoir can be adjusted by the negative pressure generated by the negative pressure generator 400.

The second adjusting valve 300 is installed in the middle at which the other side tube branched from the output tube 100 is connected to the positive pressure generator 500 and thus the device controls the operation of the second adjusting valve so that the amount of air to be injected to the ink reservoir can be adjusted by the positive pressure generated by the positive pressure generator 500.

The control unit 600 controls the first adjusting valve 200 and the second adjusting valve 300 to adjust the pressure of the ink reservoir connected through the output tube 100. Specifically, the control unit 600 sets the internal pressure of the ink reservoir to a specific value at which the inkjet head can maintain a meniscus state and controls the first adjusting valve 200 and the second adjusting valve 300 so that the pressure is maintained to the predetermined pressure value. So as to maintain the meniscus state, since the inside of the ink reservoir must be maintained at a negative pressure state, it may be considered that only the negative pressure generator 400 is required. However, since there are a case where positive pressure is applied during the process of discharging ink from the inkjet head and a case where positive pressure must be applied for the management of the ink circulation system, in this embodiment, the negative pressure generator 400 and the positive pressure generator 500 are provided together.

The pressure sensor 700 is a sensor which measures the pressure in the output tube 100. The pressure in the output tube 100 is determined according to the operation of the first adjusting valve 200 and the second adjusting valve 300 and is a pressure applied to the ink reservoir through the entire pressure adjusting device.

In the pressure adjusting device of the present embodiment, the control unit 600 determines the pressure measured by the pressure sensor 700 as the pressure output from the pressure adjusting device, and performs the control, and thus the pressure sensor 700 is positioned to measure the pressure of a portion at which the output tube 100 is branched or a portion before the output tube 100 is branched. However, in a case where the control is performed on the basis of the value measured by the pressure sensor 700 positioned in the output tube 100, the internal pressure of the ink reservoir cannot be controlled to a predetermined value, and a minute error occurs.

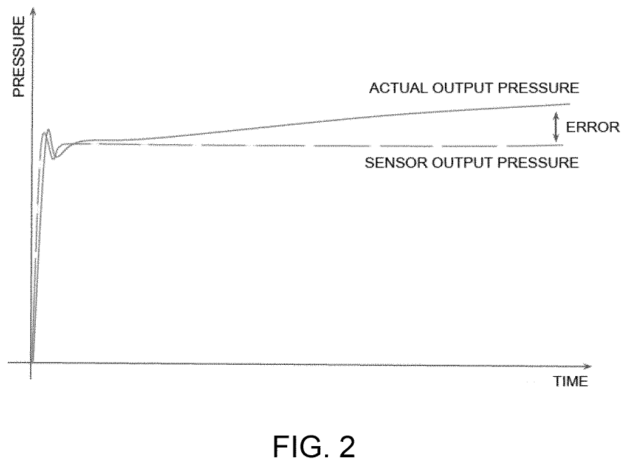

FIG. 2 is a graph illustrating a comparison between a pressure measured from a pressure sensor of a pressure adjusting device according to an embodiment of the present invention and an actual pressure measured externally.

The graph illustrated in long-dashed line is a graph illustrating the pressures measured by the pressure sensors 700 installed in the output tube 100 and the graph illustrated in solid line is a graph illustrating the pressure measured by the external pressure sensor at a position spaced apart from the outlet tube by a predetermined distance by connecting a tube to the outlet tube 100.

The control unit 600 is set so that the pressure adjusting device operates constantly at a predetermined output pressure and then operates the pressure adjusting device. The pressure illustrated in long-dashed line measured by the pressure sensor 700 can be checked to be changed from 0 to a negative value or a positive value while the pressure adjusting device is operated, to be controlled so as to maintain the predetermined output pressure value, and thus to be measured as a constant value after a predetermined time. This is because the operation of the control unit 600 itself is adjusted based on the value of the pressure sensor 700 which measures the pressure in the output tube 100.

On the other hand, in the solid line graph measured by the external pressure sensor, it can be checked that a pressure difference is generated with the parallax compared to the long-dashed line graph on the characteristics of a position at which the external pressure sensor is installed at the outside, and initially, the same constant pressure value as the long-dashed line graph is maintained, and the pressure value gradually changes, causing a difference from the long-dashed line graph.

The solid line graph corresponds to the actual pressure applied to the ink reservoir since the solid line graph is a value measured by an external pressure sensor at a position which is spaced apart by a predetermined distance, and hereinafter, the pressure value of the long-dashed line graph is referred to as a ‘sensor output pressure’, and the pressure value of the solid line graph is referred to as an ‘actual output pressure’. As a result, since the sensor output pressure based on which the control unit 600 controls is different from the actual output pressure applied to the ink reservoir, it can be seen that an error occurs during the pressure control process of the ink reservoir.

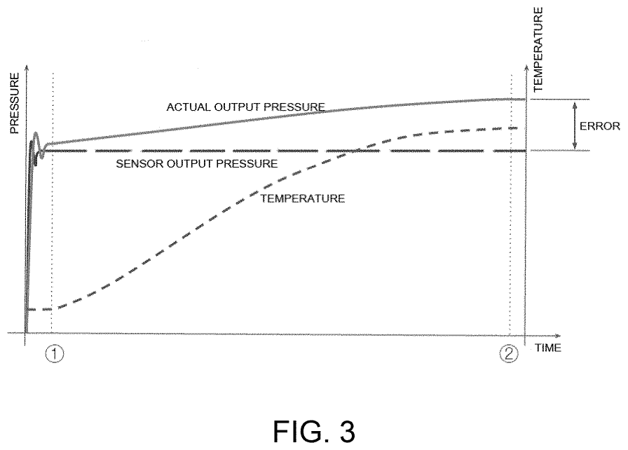

The inventors of the present invention have checked by research that the difference generated in the graph of FIG. 2 is a problem due to temperature, and FIG. 3 is a graph in which the temperature change with time is added to the graph of FIG. 2. As illustrated, it can be checked that an error occurs between the sensor output pressure and the actual output pressure from the moment when the measured temperature value indicated by the dashed line exceeds the specific temperature of a first point (indicated by \textcircled{1}) on the time axis, and as the temperature rises, the error becomes large in the sensor output pressure and the actual output pressure, and the error value is maintained constant if the temperature does not rise any more from a second point (indicated by \textcircled{2}) on the time axis.

The pressure of the gas is also affected by the temperature based on the Ideal gas law (general gas equation), and in a case where the inkjet printer is operated, the heat generated from the control unit 600 itself constituted of various electronic components and the heat generated from various components of the pressure adjusting device such as the first adjusting valve 200, the second adjusting valve 300, the negative pressure generator 400, and the positive pressure generator 500 raise the temperature around the pressure sensor 700. Further, the temperature around the pressure sensor 700 may rise due to heat generated from a component outside the pressure adjusting device. As a result, the temperature of the portion measured by the pressure sensor 700 continuously increases, and accordingly, the sensor output pressure measured by the pressure sensor 700 is different from the actual output pressure.

Accordingly, the inventors of the present invention have added a temperature sensor 800 and configured to perform temperature-dependent correction on the sensor output pressure measured by the pressure sensor 700.

Since the temperature sensor 800 is for correcting the pressure measured by the pressure sensor 700, the temperature sensor is installed at a position where the temperature around the pressure sensor 700 can be measured.

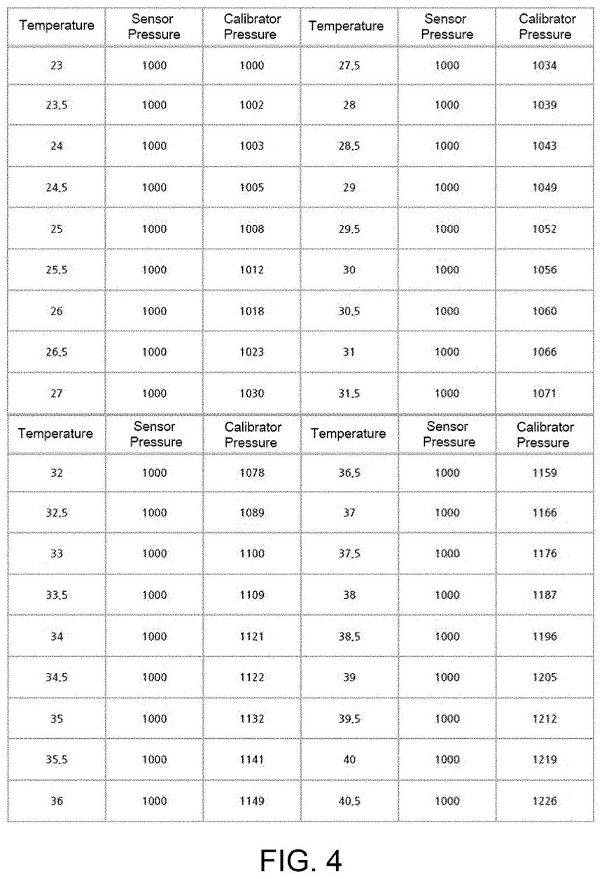

FIG. 4 is a temperature compensation table written for correction with respect to a pressure sensor in a pressure adjusting device according to an embodiment of the present invention.

Since the inherent characteristic is shown according to the type of the pressure sensor 700, or the like, it is difficult to correct the pressure to a constant value, and in this embodiment, a temperature compensation table is separately written with respect to the sensor and input to the control unit 600.

The control unit 600 controls the pressure adjusting device based on the ‘corrected sensor output pressure’ which reflects the temperature compensation table of FIG. 4 to the temperature value measured by the temperature sensor 800 with respect to the pressure measured by the pressure sensor 700.

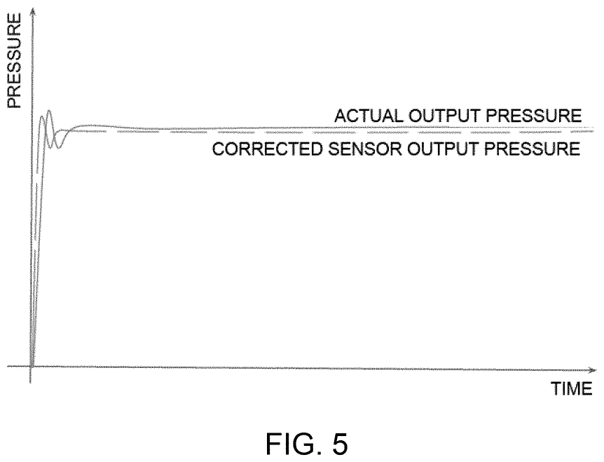

FIG. 5 is a graph comparing an corrected sensor output pressure, which reflects the temperature compensation of a pressure adjusting device according to an embodiment of the present invention, and an actual pressure measured externally.

The graph illustrated in long-dashed line is a ‘corrected sensor output pressure’ obtained by correcting the sensor output pressure according to the temperature compensation table based on the temperature value measured by the temperature sensor 800, and graph illustrated in solid line is an ‘actual output pressure’ measured by the external pressure sensor at position which is spaced apart by a predetermined distance. As a result of the control unit 600 controlling the pressure adjusting device based on the corrected sensor output pressure, it can be checked that an error hardly occurs between the corrected sensor output pressure and the actual output pressure.

Meanwhile, FIG. 1 illustrates a configuration in which one adjusting valve is provided for each of the negative pressure generator and the positive pressure generator, but, the present invention is not limited to this, and further adjusting valves, a negative pressure generator, or a positive pressure generator may be provided so as to control more precisely. For example, it is possible to perform more precise pressure adjusting by installing a plurality of adjusting valves in a tube connected to the negative pressure generator, and individually controlling the plurality of adjusting valves, or a plurality of negative pressure generators can be installed and adjusting valves can be installed in each of the negative pressure generators. At this time, so as to control each adjusting valve, a plurality of pressure sensors may be installed in the pressure adjusting device, and it is configured so that temperature correction is performed on each of the plurality of pressure sensors. Further, since there may be a difference in temperature due to the difference in the positions where the plurality of pressure sensors are installed, a plurality of temperature sensors can be applied to each of the plurality of pressure sensors so that the temperature around each of the plurality of pressure sensors can be measured. In addition, a temperature compensation table can be separately written for each of the plurality of pressure sensors and is input to the control unit.

As described above, the pressure adjusting device of the present invention performs control based on a pressure sensor installed therein, and further includes a temperature sensor which measures the temperature around the pressure sensor, and performs correction according to temperature, and thus there is an effect that the actual output pressure can be controlled more accurately.

In addition, by accurately controlling the output pressure of the pressure adjusting device, it is possible to more accurately control the internal pressure of the ink reservoir, and finally, the precision of the inkjet printer can be further improved.

While the present invention has been described with reference to preferred embodiment, it is to be understood by a person skilled in the art that the embodiment described above is merely illustrative of the technical idea of the present invention and various changes thereof can be made in the scope without departing from the technical idea of the invention. Therefore, the protection scope of the present invention should be construed not by what is described in the specific embodiment, but by what is claimed in the patent claims, and all technical ideas within the equivalent scope of the same should be also construed as being included in the scope of the right of the present invention.

### EXPLANATION OF REFERENCE NUMERAL

100: output tube

200: first adjusting valve

300: second adjusting valve

400: negative pressure generator

500: positive pressure generator

600: control unit

700: pressure sensor

800: temperature sensor

R: ink reservoir

What is claimed is:

1. A pressure adjusting device of an inkjet printer comprising:
an output tube which is connected to an ink reservoir;
at least one pressure generator which is capable of changing the pressure in the ink reservoir;
an adjusting valve which is positioned between the pressure generator and the output tube;
a control unit which controls the adjusting valve to control an output pressure;
a pressure sensor which measures pressure information which is output to the output tube so that the control unit is capable of adjusting the adjusting valve; and
a temperature sensor which measures temperature information so that the control unit is capable of performing a temperature correction with respect to the pressure information measured at the pressure sensor.

2. The pressure adjusting device of an inkjet printer according to claim 1,
wherein the temperature sensor measures a temperature around the pressure sensor.

3. The pressure adjusting device of an inkjet printer according to claim 1,
wherein the pressure generator includes a negative pressure generator which generates a negative pressure and a positive pressure generator which generates a positive pressure,
wherein the adjusting valve includes a first adjusting valve which is connected to a side of the negative pressure generator and a second adjusting valve which is connected to a side of the positive pressure generator, and
wherein the output tube is branched to be connected to the first adjusting valve and the second adjusting valve, respectively.

4. The pressure adjusting device of an inkjet printer according to claim 3,
wherein the pressure sensor measures a pressure at a point where the output tube is not branched.

5. A pressure adjusting device which is connected to an ink reservoir through a tube to adjust an internal pressure of the ink reservoir comprises:
a control unit which controls a pressure output from the pressure adjusting device;
a pressure sensor which measures a pressure in the pressure adjusting device so as to provide pressure information to the control unit; and
a temperature sensor which measures temperature information in the pressure adjusting device so that the control unit performs temperature correction with respect to the pressure information measured at the pressure sensor.

6. The pressure adjusting device according to claim 5,
wherein two or more pressure sensors are installed, and
wherein the temperature sensors are provided with respect to the two of more pressure sensors, respectively.

7. A control method of a pressure adjusting device which is connected to an ink reservoir by a tube to adjust an internal pressure of the ink reservoir, comprising:
controlling an output pressure of the pressure adjusting device based on a pressure in the pressure adjusting device; and
performing a correction according to a temperature in the pressure adjusting device with respect to the pressure in the pressure adjusting device to control the output pressure.
